(19) United States
(12) Patent Application Publication
(10) Pub. No.: US 2025/0030771 A1
(43) Pub. Date: Jan. 23, 2025

(54) AUTOMATIC SOFTWARE UPDATE

(71) Applicant: HIRSCHMANN AUTOMATION AND CONTROL GMBH, Neckartenzlingen (DE)

(72) Inventors: Zbigniew PELZER, Lenningen (DE); Stephan KEHRER, Dußlingen (DE)

(73) Assignee: HIRSCHMANN AUTOMATION AND CONTROL GMBH, Neckartenzlingen (DE)

(21) Appl. No.: 18/707,294

(22) PCT Filed: Dec. 14, 2022
(86) PCT No.: PCT/EP2022/085906

§ 371 Date: May 3, 2024

(30) Foreign Application Priority Data
Dec. 22, 2021 (DE) 10 2021 134 251.1

(51) Int. Cl. H04L 67/00; G06F 8/65; H04L 41/08; H04L 41/082

(52) U.S. Cl. CPC H04L 67/34; G06F 8/65; H04L 41/082; H04L 41/0886

(57) ABSTRACT

The invention relates to a method for automating software updates and/or programming logic updates of network subscribers. A network, having a firmware master, and a plurality of network subscribers that can communicate with one another are used. The firmware master can then manually obtain new firmware. The firmware master then distributes this new firmware to all adjacent network subscribers, which, after obtaining the new firmware, check said firmware for compatibility and, in the case of compatibility, independently execute an update process. These now updated network subscribers subsequently distribute the new firmware in turn to all network subscribers adjacent thereto and thus bring about the update process of these network devices.

The present invention relates to a method for automating software updates of network devices, particularly switches.

Switches are network apparatus that connect other network participants with one another. A fixed or programmable logic within the switches ensures the addressing of the data packets that are exchanged between the network participants.

This programmable logic and/or software should be provided with updates for safety reasons and/or changes to the scope of functions. Typically, firmware updates are installed and deployed individually on network apparatus. On the one hand, this can mean a relatively large amount of effort in large networks, as each apparatus has to be supplied with the firmware individually and manually. On the other hand, such an approach also carries the risk that individual network apparatus are not updated (either because they are forgotten or because the update is not installed correctly without being noticed).

Experience teaches that even if all switches are purchased at the same time but through different sales channels, they often have different SW versions. Updating these software versions to the same, preferably the latest, version often proves to be very time-consuming and labor-intensive due to the way firmware updates are performed as described above. SW=Software.

One approach to solving the problem is to use a network management tool to provide several apparatuses in the network with the firmware update at once. Nevertheless, the risks of forgotten switches or failed updates remain.

The object of the present invention is therefore to eliminate the aforementioned problems and to provide a secure method for updating the software of switches in order to bring as many switches in a network as possible up to date.

This object is solved with the features of the claim.

A network apparatus in the network is defined as the firmware master for this purpose. When the apparatus is supplied with new firmware, the network then enters a temporary “self-organization phase” or “update phase”. The firmware is distributed from the firmware master to the neighboring apparatuses and an update of these apparatuses is triggered. After a successful update, these apparatuses in turn distribute the firmware image to their neighbors and initiate the update there. The firmware image is only passed on to those neighbors who have a different firmware version installed.

Possible ways of realization as well as additions and the rule for this property would be:
For image transmission from one switch to another, an FTP server could be implemented on all switches.
The distribution of information about the firmware status of individual apparatus could be realized with the help of LLDP (Link Layer Discovery Protocol).
The firmware version delivered by the firmware master is always the one to which all apparatuses are to be updated. Under certain circumstances, this can lead to downgrades for apparatus in the network that already have a newer firmware version installed. However, it enables all apparatus in the network to be securely updated to the same version, which is defined via the firmware master.
Alternatively: A higher firmware version is always “the better one”, which prevails in the network and eventually replaces the lower firmware versions on all apparatus.
Firmware images may only be exchanged between identical or SW-compatible apparatus. Where this is not possible and deviating firmware versions could subsequently exist, a warning message should be used to indicate this.
It would certainly also be possible to transmit the firmware between the neighboring switches using HTTP.
Another possible solution would be to use a distributed/decentralized configuration protocol.
You could also use the functionality of the SNMP agent (client) on the switch for this purpose. The switch with the “better” FW image could “remotely control” the switch with a “worse” firmware version with the help of the SNMP agent by setting its MIB variables.
It would probably also make sense to enable and disable this property of accepting the “better” firmware version from the neighboring switch with the help of a configurable parameter (e.g. a so-called AcceptBetterNeighbor firmware).

### ADVANTAGES OF THE IDEA

This would be an elegant way to solve the annoying problem of firmware updates and firmware version consistency in a network of any size completely automatically.
To do this, you would only need to install the newer firmware on one apparatus and then “leave the network to its own devices”.
This automatic firmware update would not require any external instances in the form of PCs or a technician, or any other programs such as SNMP batches or Industrial HiVision.

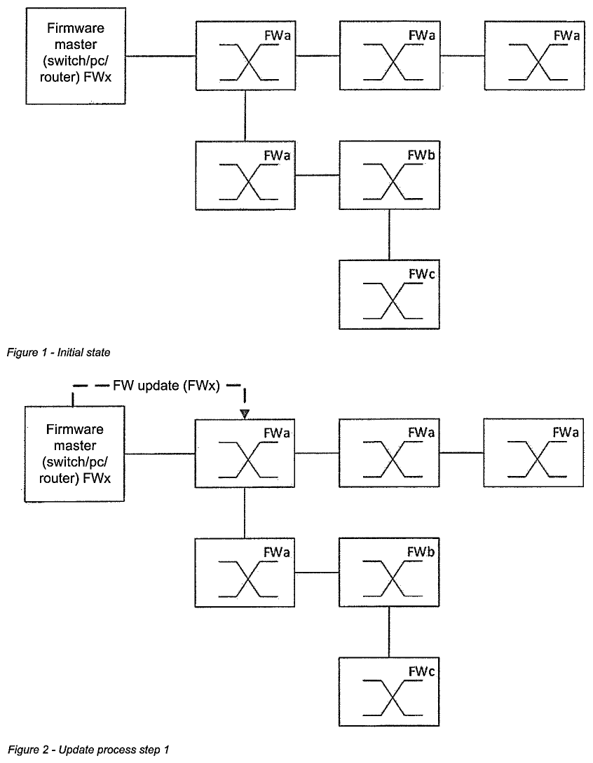

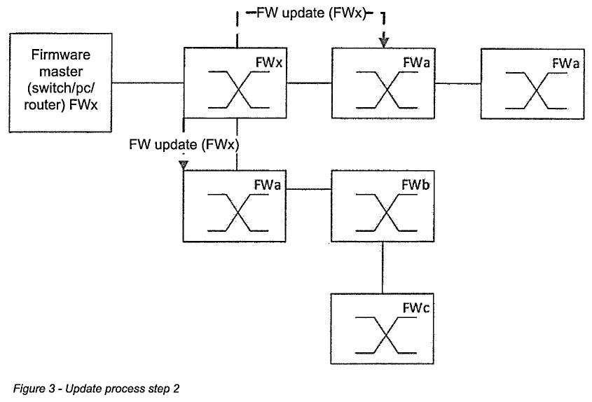

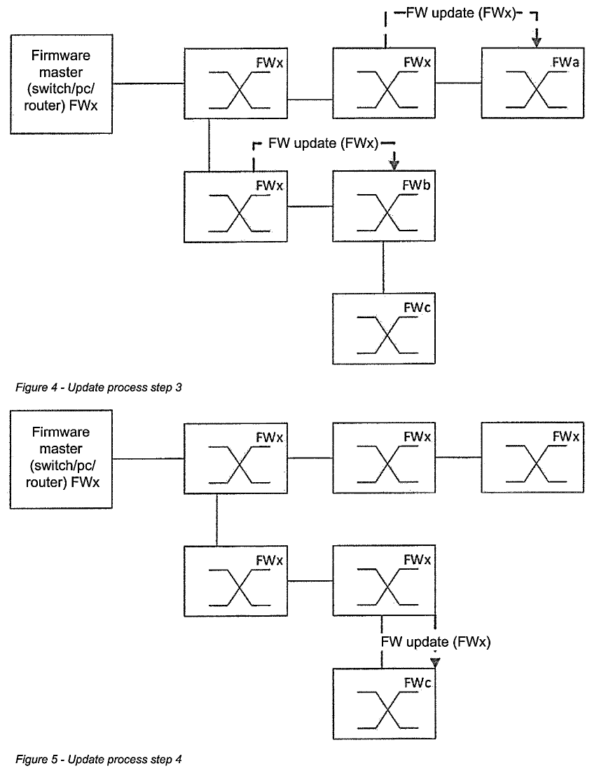

After the firmware update, it may be necessary to restart the apparatus (=network apparatus=network participants) via a boot process. The implementing of the boot process can also be automated as part of the proposed method. Such automation is shown as an example in FIGS. 1 to 5.

1.-15. (Canceled)

16. A method of automating software updates for network participants, wherein a firmware master and several network participants can communicate with one another in a network, and wherein:
the firmware master receives new firmware manually;
the firmware master then distributes this new firmware to all neighboring network participants;
after receiving the new firmware, the network participants check it for compatibility and, if compatible, carry out an update process independently; and
subsequently distribute the new firmware to all neighboring network participants.

17. The method according to claim 16, wherein the firmware master is integrated in a network subscriber.

18. The method according to claim 16, wherein the firmware master receives the new firmware via an FTP connection.

19. The method according to claim 16, wherein neighboring network participants are determined via a Link Layer Discovery Protocol (LLDP).

20. The method according to claim 16, wherein the distribution to neighboring network subscribers is performed via FTP.

21. The method according to claim 16, wherein the distribution to neighboring network participants is performed via http or HTTPS.

22. The method according to claim 16, wherein for the compatibility check, the network subscriber is identified and the firmware is compared to an entry within the network subscriber firmware.

23. The method according to claim 22, wherein the identity of the network subscriber is determined via a product number, an order designation, an order number or similar.

24. The method according to claim 16, wherein the installed firmware version is determined for the compatibility check and the update process is only carried out in the case of a newer firmware version.

25. The method according to claim 16, wherein the distribution of the firmware to the neighboring network subscribers is performed by the network subscriber that has just been updated.

26. The method according to claim 16, wherein the firmware is distributed to the neighboring network participants by the firmware master.

27. The method according to claim 16, wherein the firmware is stored in a cache of the respective network participants.

28. The method according to claim 16, wherein the distribution to neighboring network participants is carried out using an individual, particularly company-specific image transmission protocol.

29. The method according to claim 16, wherein the firmware is deleted from the cache after distribution to neighboring network subscribers.

30. The method according to claim 16, wherein the network participants are switches, routers, PC stations or similar.
